(19) United States
(12) Patent Application Publication
(10) Pub. No.: US 2011/0115814 A1
(43) Pub. Date: May 19, 2011

(54) GESTURE-CONTROLLED DATA VISUALIZATION

(75) Inventors: Scott M. Heimendinger, Seattle, WA (US); Jason G. Burns, Bellevue, WA (US)

(73) Assignee: Microsoft Corporation, Redmond, WA (US)

(21) Appl. No.: 12/618,797

(22) Filed: Nov. 16, 2009

(51) Int. Cl. G09G 5/00

(52) U.S. Cl. 345/619; 345/440; 345/173

(57) ABSTRACT

Architecture that establishes a set of gestural movements that can be made by a finger (by any other input device) on a touch display that allows a presenter to perform basic analytic functions of a data visualization such as a chart or a graph having one or more graphical elements for selection. The analytic functions can include changing the presentation format of the chart, choosing to include or exclude certain data, and/or displaying the details of a data point, for example. The gestures facilitate at least making changes to the chart (or graph) from one display method to another, such as to a pie chart, to a bar chart, to a line chart, etc., the selection of multiple elements of the data visualization, exclusion of all but selected elements therefrom, and the presentation of detailed information about an element.

### BACKGROUND

Touch-based interfaces are becoming an increasingly common standard for interacting with information displayed on computers. One of the particularly prevalent patterns that is emerging is using large, touch-enabled displays to present and analyze information in real-time. For example, in a presentation meeting, the presenter may want to physically touch an area where data is projected onto a screen or wall as a means of highlighting that data point. Similarly, newscasters are more commonly relying on using touch-enabled displays to present information, such as charts or graphs, to the audience. However, existing touch-based interfaces do not provide flexibility in adjusting how data is presented, for example.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

The disclosed architecture establishes a set of gestural movements that can be made by a finger (by any other input device) on a touch display that allows a presenter to perform basic analytic functions of a data visualization such as a chart or a graph having one or more graphical elements for selection. The analytic functions can include changing the presentation format of the chart, choosing to include or exclude certain data, and/or displaying the details of a data point, for example.

The gestures facilitate at least making changes to the chart (or graph) from one display method to another, such as to a pie chart, to a bar chart, to a line chart, etc., the selection of multiple elements of the data visualization, exclusion of all but selected elements therefrom, and the presentation of detailed information about an element.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates a computer-implemented graphical interaction system in accordance with the disclosed architecture.

FIG. 2 illustrates a system that shows additional details associated with the gesture processing component.

FIG. 3 illustrates a set of data visualizations for conversion of a bar chart visualization to a pie chart visualization.

FIG. 4 illustrates a set of data visualizations for conversion of a bar chart visualization to a line chart visualization.

FIG. 5 illustrates a set of data visualizations for conversion of a line chart visualization to a bar chart visualization.

FIG. 6 illustrates a bar chart visualization where data other than that selected is removed.

FIG. 7 illustrates that the category not selected has been removed from the resulting bar chart visualization.

FIG. 8 illustrates data visualizations where specific data selection in a bar chart visualization using one or more corresponding gestures.

FIG. 9 illustrates a computer-implemented graphical interaction method.

FIG. 10 illustrates additional aspects of the method of FIG. 9.

FIG. 11 illustrates additional aspects of the method of FIG. 9.

FIG. 12 illustrates a block diagram of a computing system operable to execute graphical interaction via gestures in accordance with the disclosed architecture.

### DETAILED DESCRIPTION

The disclosed architecture establishes a set of gestural movements that can be made by a finger on a touch display, for example, or by any other input device, that allows a presenter to perform basic analytic functions on a chart or graph or other type of data visualization. These analytic functions may include changing the presentation format of the chart, choosing to include or exclude certain data, or displaying the details of a data point.

Using a human input device such as the tip of a finger or fingers on a touch-enabled display, a user can make gestures on top of a chart control, for example, to interact with that chart control. A chart control may be any graphical visualization of data, such as a chart object in a presentation application.

Charts, for example, can take on any number of forms to graphically visualize the data represented. The most common forms of charts are bar charts, line charts, and pie charts. Each chart type offers different benefits and drawbacks for presenting certain data sets. Thus, during the course of analyzing or presenting data, a user may wish to change the form of the chart. The user may utilize a known gesture to indicate to the system to change the chart form. Described infra are gestures that can be employed. Other gestures not described can be provided and implemented as desired.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

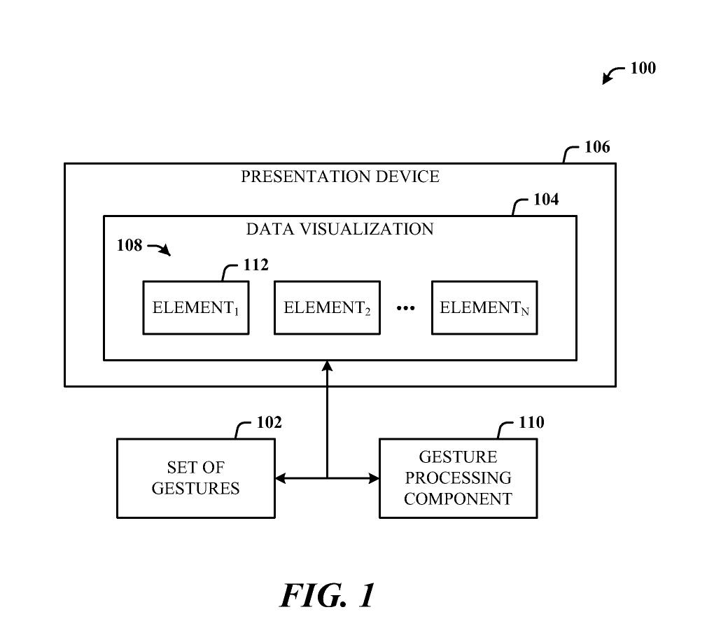

FIG. 1 illustrates a computer-implemented graphical interaction system 100 in accordance with the disclosed architecture. The system 100 includes a set of gestures 102 for interaction with a data visualization 104 presented by a presentation device 106. The data visualization 104 includes one or more graphical elements 108 responsive to the gestures 102. The system 100 can also include a gesture processing component 110 that receives a gesture relative to a graphical element of the data visualization 104 and changes presentation of the data visualization 104 in response to the gesture (or processing of the gesture).

A gesture can be any input generated by the user using human interface devices such as a mouse, keyboard, laser pointer, stylus pen, and so on, and/or human motions such as hand gestures, finger motions, eye movement, voice activation, etc., or combinations thereof. All human motions are also referred to as anatomical interactions that require a body part to make the gesture directly for capture or sensing and interpretation as to an associated function. For example, eye movement captured by a camera can be processed to execute a function that switches from a pie chart to a line chart. Similarly, finger movement relative to a touch-enabled display can be sensed and interpreted to execute a function that switches from a bar chart to pie chart.

Gestures can be approximated, as users will typically not be able to express motion precisely along a path anatomically and/or with other input devices. Well-known algorithms for matching a user-entered gesture to a list of known gestures can be invoked in response to the user's input. Consider the following example results for changing the form of data visualizations.

Conversion from a non-pie chart to a pie chart can be accomplished using a finger gesture that includes touching a starting point toward the exterior boundary of the non-pie chart with a finger, moving the finger in a circular arc around the chart area, and then returning to the starting point of the gesture. The motion can be clockwise and/or counterclockwise. After the gesture is complete, the non-pie chart is re-presented in the form of a pie chart, according to known algorithms. IN other words, the set of gestures 102 can include one or a combination (sequentially performed or performed in parallel with another gesture) of gestures that allow changing presentation of the data visualization 104 to a pie chart.

Conversion from a non-line chart to a line chart can be accomplished using a gesture that includes touching a point on the left- or right-hand side of the non-line chart near the middle on the vertical axis using a finger, and then moving the finger to the opposite side of the chart in a slightly wavy line. After the gesture is complete, the non-line chart is re-presented in the form of the line chart, according to known algorithms. In other words, the set of gestures 102 can include one or a combination of gestures that allow changing presentation of the data visualization 104 to a line chart.

If it is desired to show only certain data points of the data visualization, one or more gestures can be performed that include identifying which data points should be preserved on the chart, and then making a gesture to remove all other data points from the chart. For example, the user can identify which data points to keep for the next re-presentation by tapping once on a legend entry for that data point or set, or by tapping once on the data point or set as is drawn on the chart. For instance, on a bar chart, the user can employ a gesture associated with tapping the graphical elements related to a bar containing the data to be retained. This gesture can be defined to be performed once per data point that the user wants to retain. Tapping a selected data point a second time can be defined as a de-select gesture that de-selects the data point. Put another way, the set of gestures 102 can include one or more or a combination of gestures that allow selection of multiple elements of the data visualization 104.

In combination with the gesture above for selection of the data points, using a two-finger gesture, motioning back and forth (right to left and left to right) in the data visualization area as if to shake the chart object results in re-presenting only the data points the user indicated to retain (or keep), according to known algorithms. In other words, the set of gestures 102 can also include one or a combination of gestures that allow exclusion of all elements, except selected elements of the data visualization 104.

The set of gestures 102 can also include a gesture that comprises touching a point on or around a data point on the area of a chart using a finger, and then moving the finger in a small circle around part or all of that data point. After the gesture is complete, further details about the selected data point are displayed on the chart, according to specific implementations. In other words, the set of gestures 102 can also include one or a combination of gestures that when interpreted show additional detail information about the element.

The gesture processing by the gesture processing component 110 involves recognizing that a specific gesture has been performed, matching the gesture to a function (e.g., in a lookup table of gestures-function associations), applying the function to the underlying data baseline to which the data visualization is associated, and regenerating an updated data visualization based on results of the function being processed against the underlying baseline data. This is in contrast to the simple processes in conventional implementations of increasing the size a chart (or chart image) or reducing a chart (or chart image), which do not rebuild the chart using additional data points from the underlying baseline data.

Put another way, one or a combination of the gestures in the set of gestures 102 can cause access to underlying data of the data visualization 104 to update the data visualization 104 according to an analytical function associated with one or a combination of gestures. The set of gestures 102 facilitates direct input by anatomical interaction (of or relating to body structures) with the presentation device 106 or indirect input by interaction via an input device (e.g., mouse). The set of gestures 102 can include one or a combination of gestures that allow changing presentation of the data visualization 104 to a bar chart.

As previously indicated, the data visualization 104 can be comprised of the elements 108 some or all of which are programmed to be responsive to user interaction. For example, a first element 112 can be a single pixel (picture element) programmed to an underlying single piece of data, or multiple pixels as a group any member pixel of which is associated with a specific set of data.

Described another way, the computer-implemented graphical interaction system 100 comprises the set of gestures 102 for interaction with the data visualization 104 presented by the presentation device 106. The data visualization 104 includes one or more graphical elements 108 responsive to the gestures. The system 100 also includes the gesture processing component 110 that receives a gesture relative to a graphical element from direct input by anatomical interaction with the presentation device 106 or indirect input by interaction via an input device, and changes presentation of the data visualization 104 in response thereto based on application of one or more analytical functions.

The set of gestures 102 include one or more gestures that when received relative to the one or more graphical elements 108 and processed by the gesture processing component 110 allow changing presentation of the data visualization 104 to a different presentation form that includes a pie chart, bar chart, a line chart, or a graph.

The set of gestures 102 include one or more gestures that when received relative to the one or more graphical elements 108 are processed by the gesture processing component 110 to allow selection of multiple graphical elements. The set of gestures 102 include one or more gestures that when received relative to the one or more graphical elements 108 are processed by the gesture processing component 110 to allow exclusion of all graphical elements except selected graphical elements of the data visualization 104. The set of gestures 102 include one or more gestures that when received relative to the one or more graphical elements 108 are processed by the gesture processing component 110 to cause additional details about the one or more graphical elements 108 to be computed and presented.

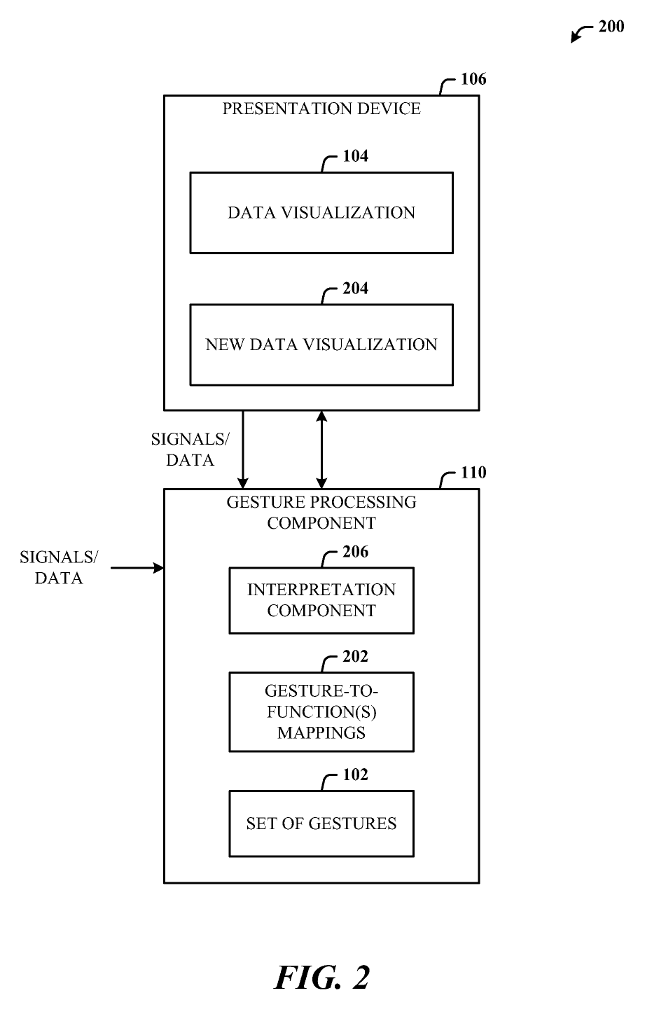

FIG. 2 illustrates a system 200 that shows additional details associated with the gesture processing component 110. This gesture processing component 110 can include the capabilities to receive signals/data related to a gesture that when processed (e.g., interpreted) allow the matching and selection of function(s) (e.g., analytical) associated with the gesture. The signals/data can be received from other device subsystems (e.g., input devices and associated interfaces such as mouse, keyboard, etc.) suitable for creating such signals/data. Alternatively, or in combination therewith, the signals/data can be received from remote devices or systems such as video cameras, imagers, voice recognition systems, optical sensing systems, and so on, essentially any systems that can sense inputs generated by the user. The signals/data can be processed locally by the device operating system and/or client applications suitable for such purposes.

In this alternative embodiment, the gesture processing component 110 includes the set of gestures 102, which can be a library of gesture definitions that can be employed for use. Alternatively, the set of gestures 102 can be only those gestures enabled for use, while other gesture definitions not in use are maintained in another location.

The gesture processing component 110 can also include gesture-to-function(s) mappings 202. That is, a single gesture can be mapped to a single function or multiple functions that effect presentation of the data visualization 104 into a new data visualization 204, and vice versa.

Additionally, the gesture processing component 110 can include an interpretation component 206 that interprets the signals/data into the correct gesture. As shown, the signals/data can be received from the presentation device 106 and/or remote device/systems (e.g., an external camera system, recognition system, etc.). When the signals/data are received, the interpretation component 206 processes this information to arrive at an associated gesture, as defined in the set of gestures 102. Once determined, the associated gesture is processed against the mappings 202 to obtain the associated function(s). The function(s) is/are then executed to effect manipulation and presentation of the data visualization 104 into the new data visualization 204.

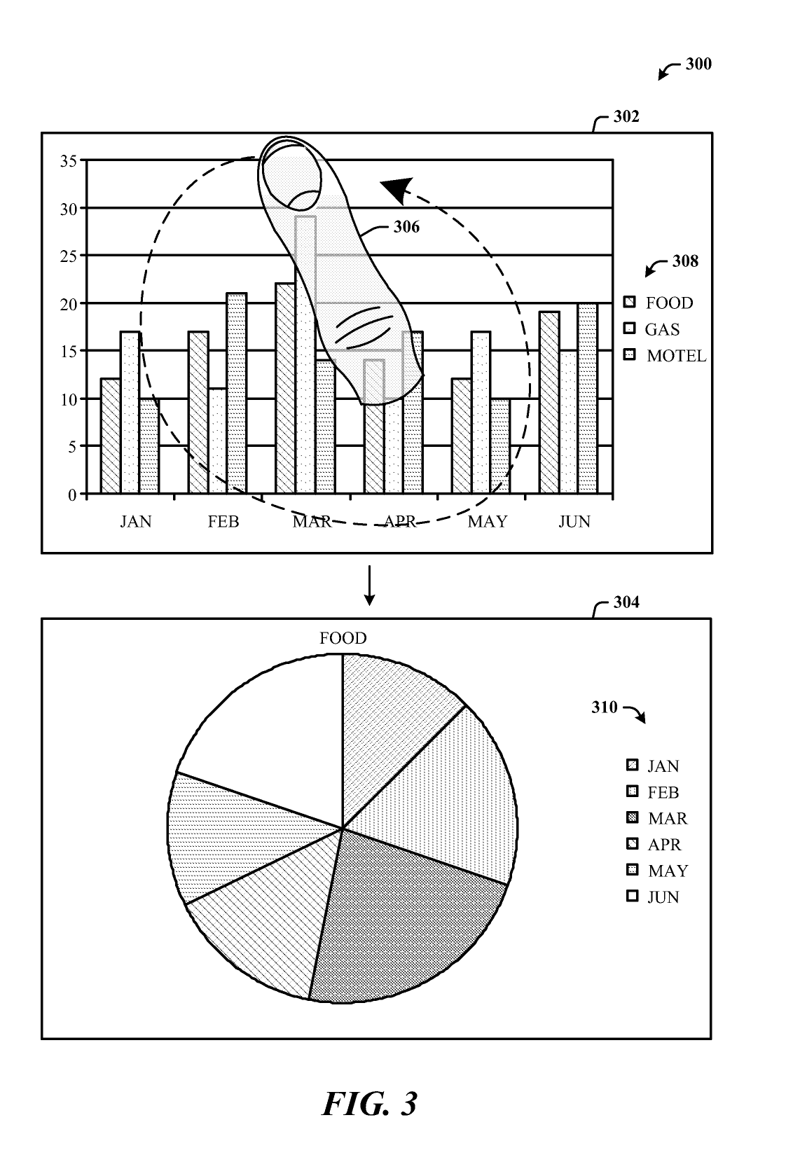

FIG. 3 illustrates a set of data visualizations 300 for conversion of a bar chart visualization 302 to a pie chart visualization 304. Here, the user makes a generally circular gesture in the bar chart visualization 302 using a finger 306, thereby indicating that the pie chart visualization 304 is desired to be created using the data as derived for the bar chart visualization 302. The finger 306 can actually contact the presentation device which processes movement of the contact point over the display surface. Alternatively, the finger 306 does not make contact with the display surface, but the motion of the gesture is captured by a sensing system that sends signals/data to the gesture processing component, which processes the signals/data and applies function(s) that generate the pie chart visualization 304.

Here, the user selected the Food graphical element 308 followed by the circular gesture to create the pie chart visualization 304 for the category of Food over a six month period. Notice that the function(s) can include automatically creating a Month legend 310 in the pie chart visualization 304 as well as creating proportional representations of the food amounts for each month section identified in the legend 310. The function(s) can also include applying different colors to each of the pie sections according to the legend 310.

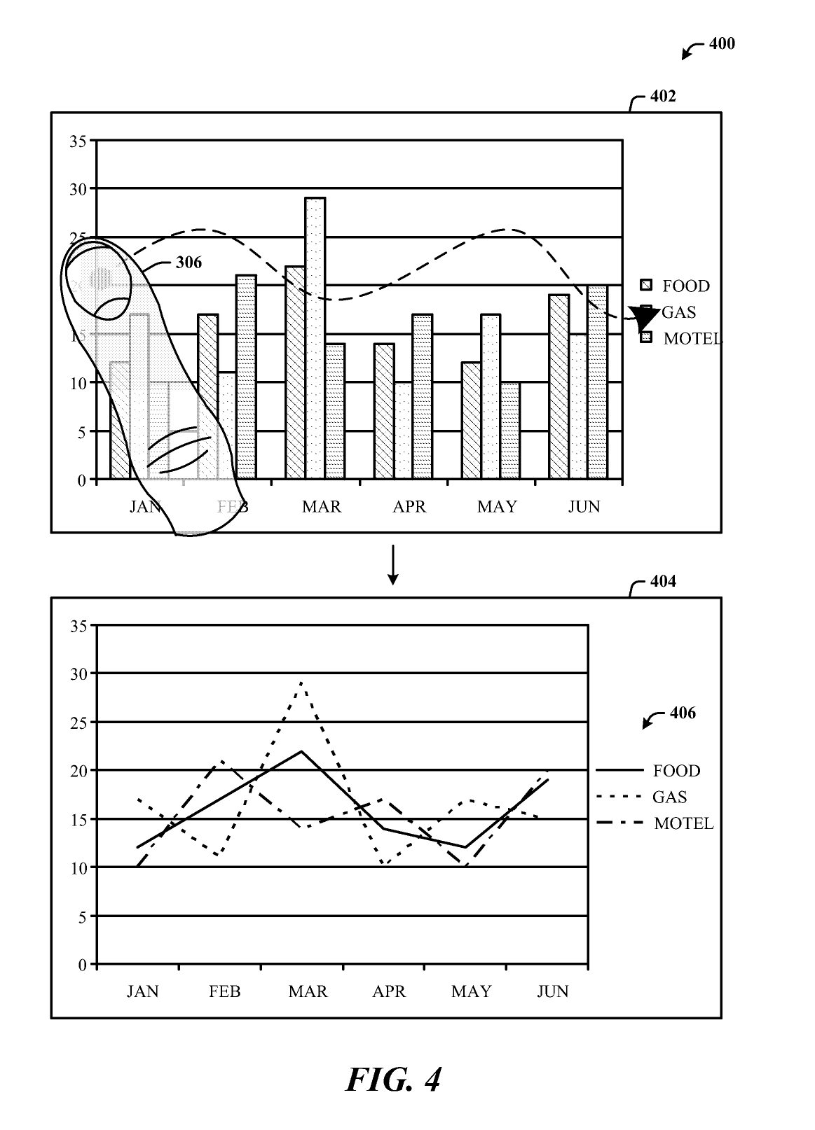

FIG. 4 illustrates a set of data visualizations 400 for conversion of a bar chart visualization 402 to a line chart visualization 404. Here, the user makes a generally wavy line gesture in the bar chart visualization 402 from one border to an opposing border using the finger 306, thereby indicating that the line chart visualization 404 is desired to be created using the data as derived for the bar chart visualization 402. The finger 306 can actually contact the presentation device which processes movement of the contact point over the display surface. Alternatively, the finger 306 does not make contact with the display surface, but the motion of the gesture is captured by a sensing system that sends signals/data to the gesture processing component, which processes the signals/data and applies function(s) that generate the line chart visualization 404.

Here, all categories of the bar chart visualization 402 are converted into corresponding line graphs in the line chart visualization 404, with the same month time period and vertical axis increments. Note that the function(s) can include automatically creating a category legend 406 in the line chart visualization 404. The function(s) can also include applying different line types and/or colors to each of the line graphs according to the legend 406.

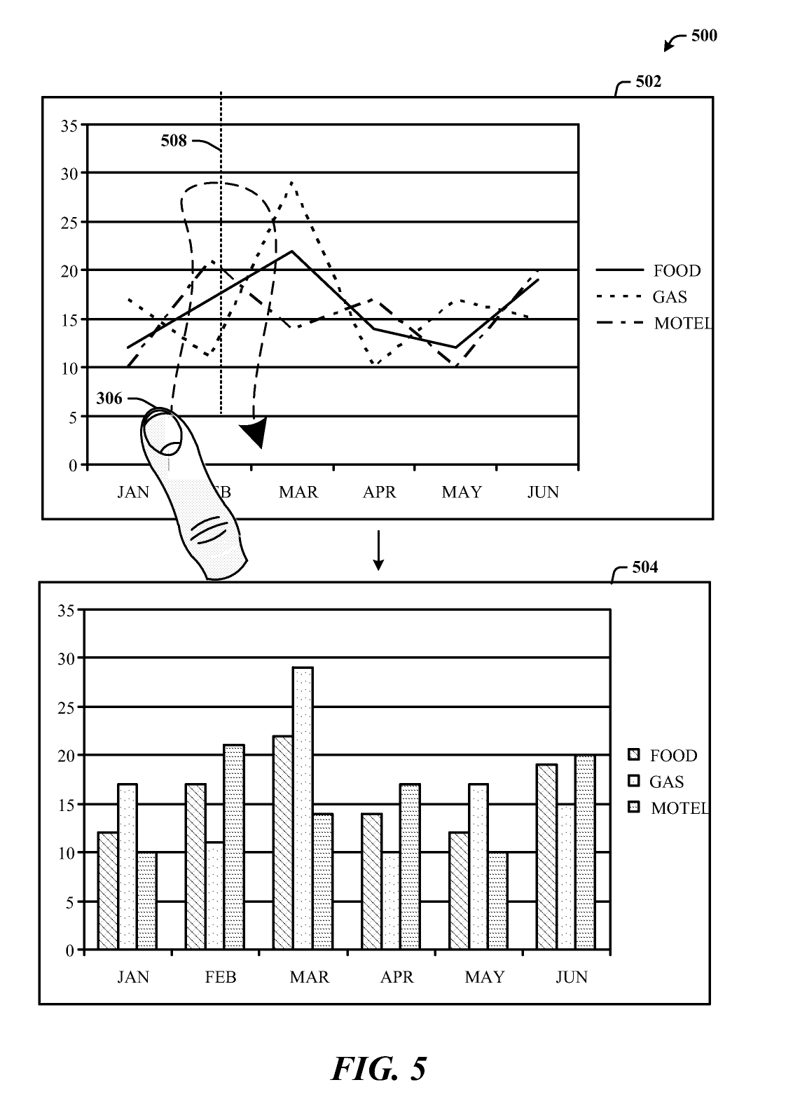

FIG. 5 illustrates a set of data visualizations 500 for conversion of a line chart visualization 502 to a bar chart visualization 504. Here, the user makes a generally a bi-directional gesture along an imaginary vertical axis 508 in the line chart visualization 502 using the finger 306, thereby indicating that the bar chart visualization 504 is desired to be created using some data as derived for the line chart visualization 502.

The finger 306 can actually contact the presentation device which processes movement of the contact point over the display surface. Alternatively, the finger 306 does not make contact with the display surface, but the motion of the gesture is captured by a sensing system that sends signals/data to the gesture processing component, which processes the signals/data and applies function(s) that generate the bar chart visualization 504.

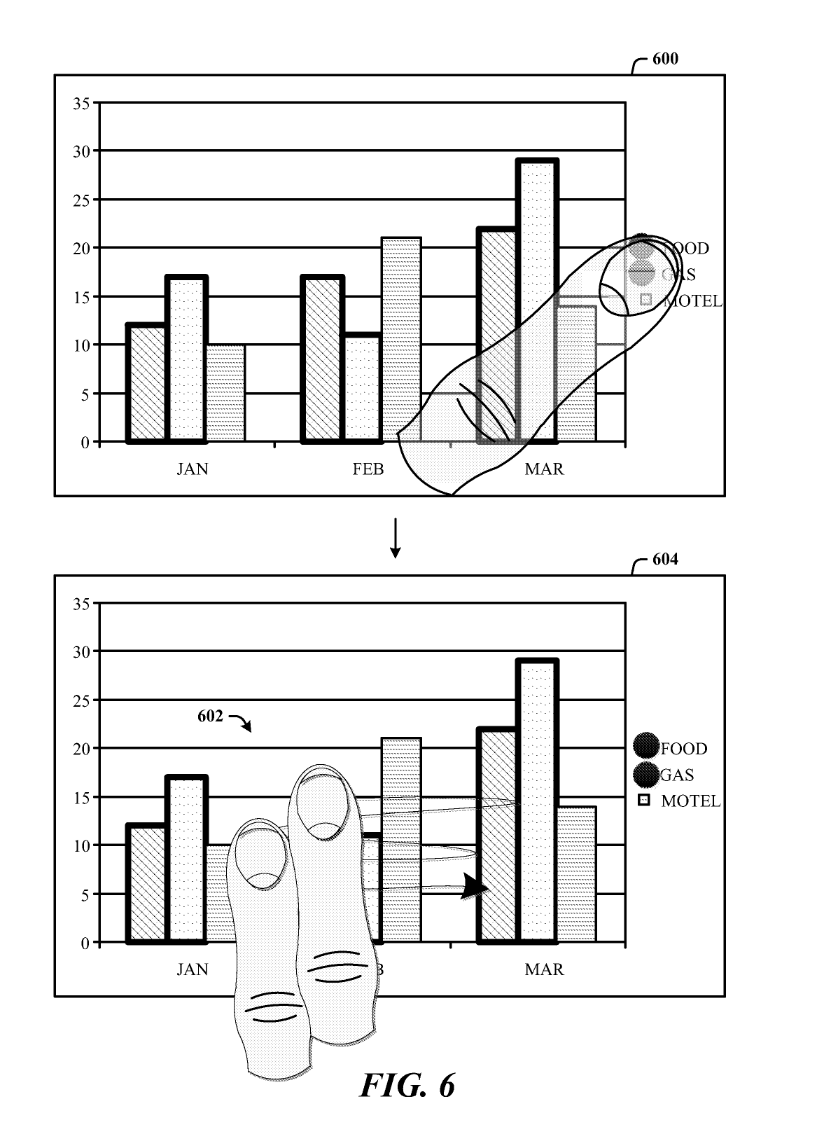

FIG. 6 illustrates a bar chart visualization 600 where data other than that selected is removed. Here, the user selects the categories of data to retain such as Food and Gas. As the user makes the selections, the corresponding bar data is emphasized (e.g., highlighted, colored, etc.) on the bar chart visualization 600 to indicate to the viewer that it was selected.

When the selections are completed, the user can use one or two fingers 602 moved in an erasing (or shake) motion (left-right), as indicated in view 604. This motion is captured and interpreted by the gesture processing component to remove data that was not selected.

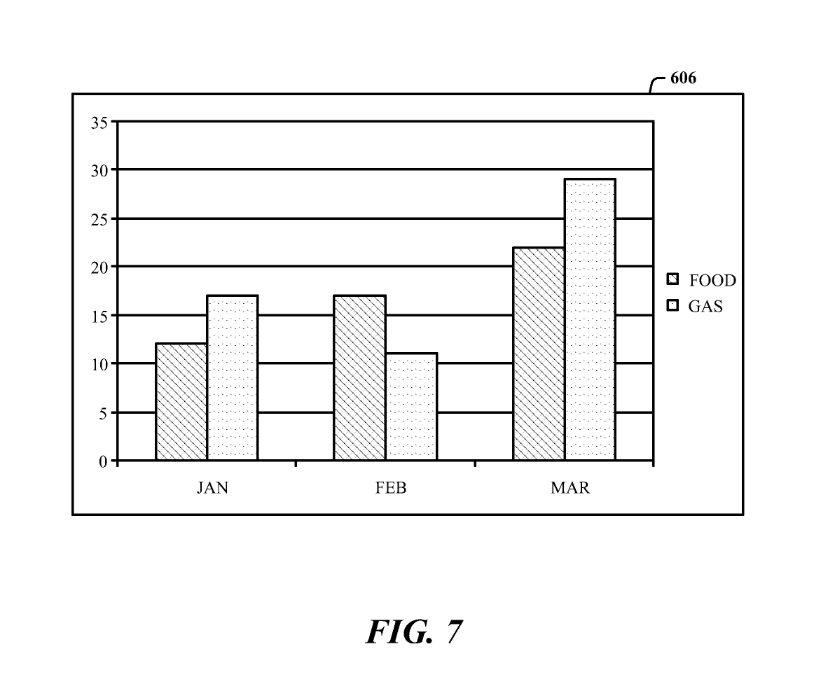

The fingers 602 can actually contact the presentation device which processes movement of the contact point over the display surface. Alternatively, the fingers 602 do not make contact with the display surface, but the motion of the gesture is captured by a sensing system that sends signals/data to the gesture processing component, which processes the signals/data and applies function(s) that generate the resulting bar chart visualization 606 in FIG. 7. FIG. 7 illustrates that the category not selected (Motel) has been removed from the resulting bar chart visualization 606.

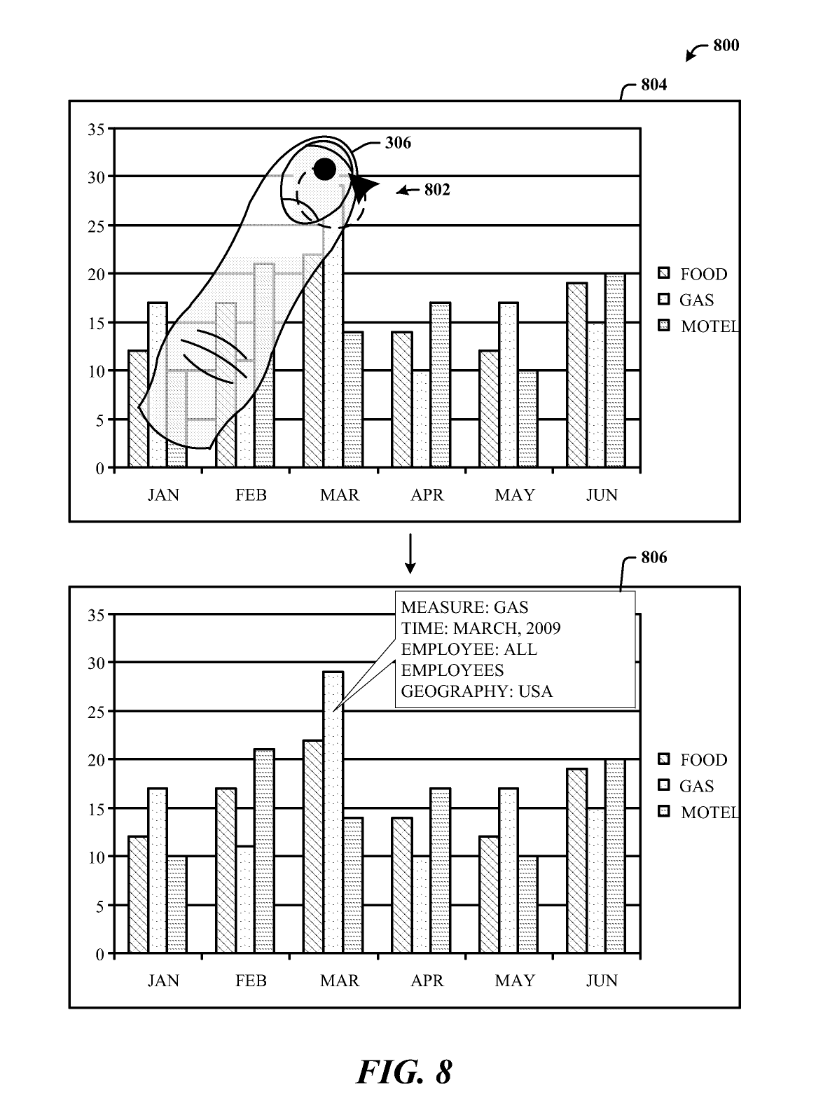

FIG. 8 illustrates data visualizations 800 where specific data selection 802 in a bar chart visualization 804 using one or more corresponding gestures. Here, the user moves the finger 306 as a select gesture that when processed selects a data point of the bar chart visualization 804 proximate a bar element. The user then performs a details gesture that generally circumscribes the selected data point and when processed presents additional details 806 associated with the selected data point as a popup window, for example, the overlays the bar chart visualization and points to the related bar element.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

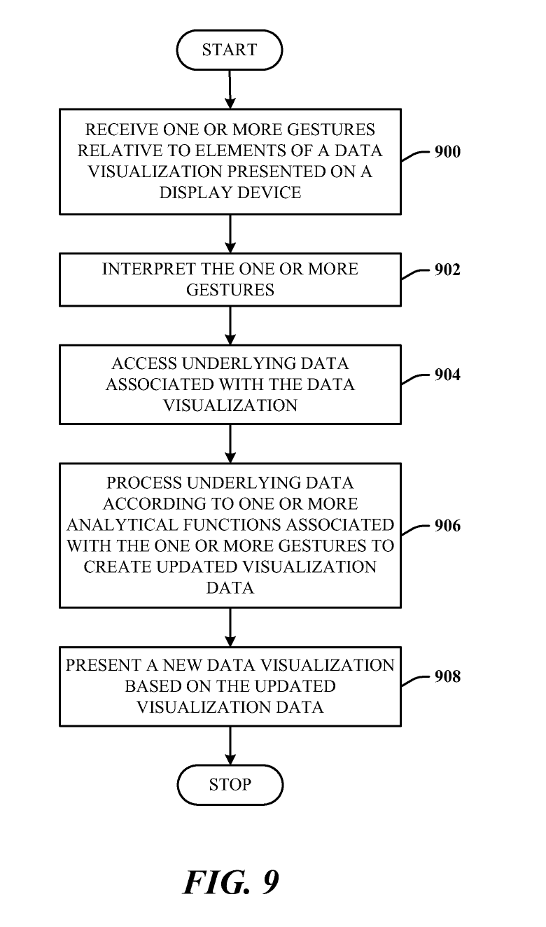

FIG. 9 illustrates a computer-implemented graphical interaction method. At 900, one or more gestures are received relative to elements of a data visualization presented on a display device. At 902, the one or more gestures are interpreted. This can be accomplished by the gesture processing component. At 904, underlying data associated with the data visualization is accessed. The underlying data can be stored and retrieved from a database, lookup table, system memory, cache memory, etc. At 906, the underlying data is processed according to one or more analytical functions associated with the one or more gestures to create updated visualization data. At 908, a new data visualization is presented based on the updated visualization data.

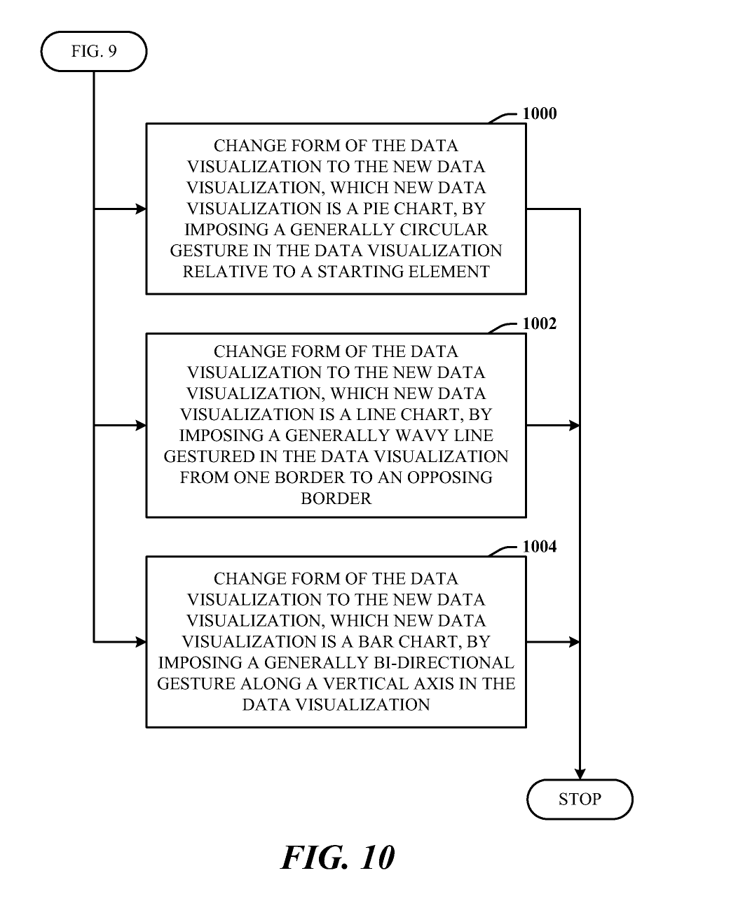

FIG. 10 illustrates additional aspects of the method of FIG. 9. At 1000, the form of the data visualization is changed to the new data visualization, which new data visualization is a pie chart, by imposing a generally circular gesture in the data visualization relative to a starting element. At 1002, the form of the data visualization is changed to the new data visualization, which new data visualization is a line chart, by imposing a generally wavy line gestured in the data visualization from one border to an opposing border. At 1004, form of the data visualization is changed to the new data visualization, which new data visualization is a bar chart, by imposing a generally bi-directional gesture along a vertical axis in the data visualization.

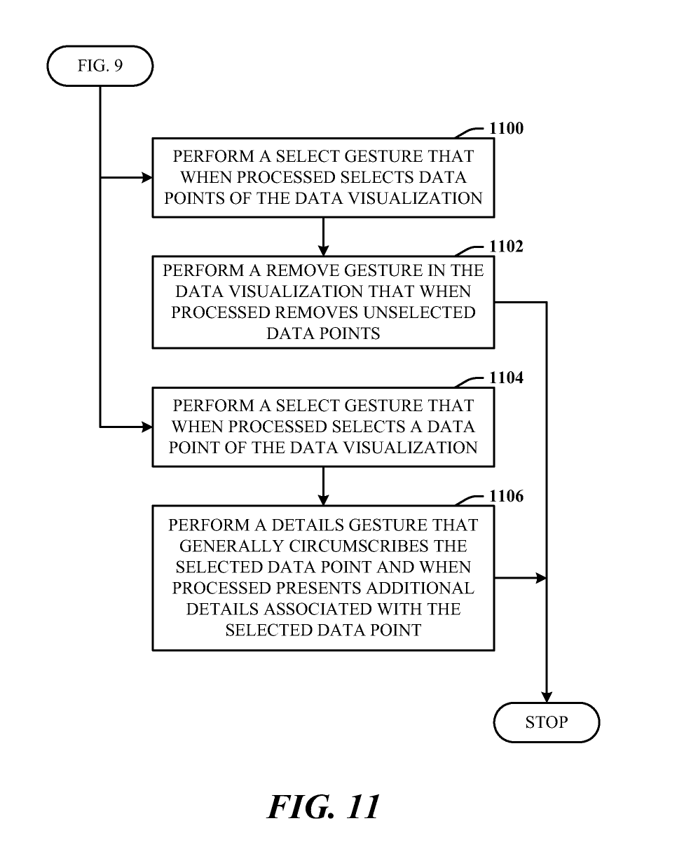

FIG. 11 illustrates additional aspects of the method of FIG. 9. At 1100, a select gesture is performed that when processed selects data points of the data visualization. At 1102, a remove gesture is performed in the data visualization that when processed removes unselected data points. At 1104, a select gesture is performed that when processed selects a data point of the data visualization. At 1106, a details gesture is performed that generally circumscribes the selected data point and when processed presents additional details associated with the selected data point.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical, solid state, and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. The word “exemplary” may be used herein to mean serving as an example, instance, or illustration. Any aspect or design described herein as “exemplary” is not necessarily to be construed as preferred or advantageous over other aspects or designs.

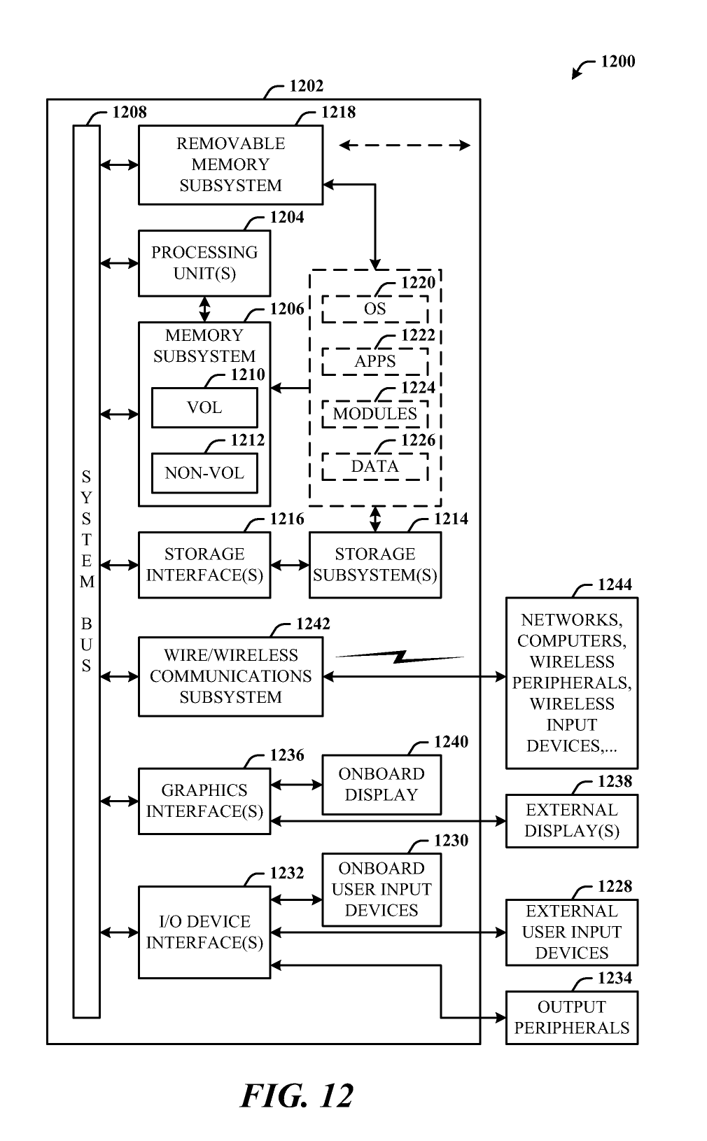

Referring now to FIG. 12, there is illustrated a block diagram of a computing system 1200 operable to execute graphical interaction via gestures in accordance with the disclosed architecture. In order to provide additional context for various aspects thereof, FIG. 12 and the following description are intended to provide a brief, general description of the suitable computing system 1200 in which the various aspects can be implemented. While the description above is in the general context of computer-executable instructions that can run on one or more computers, those skilled in the art will recognize that a novel embodiment also can be implemented in combination with other program modules and/or as a combination of hardware and software.

The computing system 1200 for implementing various aspects includes the computer 1202 having processing unit(s) 1204, a computer-readable storage such as a system memory 1206, and a system bus 1208. The processing unit(s) 1204 can be any of various commercially available processors such as single-processor, multi-processor, single-core units and multi-core units. Moreover, those skilled in the art will appreciate that the novel methods can be practiced with other computer system configurations, including minicomputers, mainframe computers, as well as personal computers (e.g., desktop, laptop, etc.), hand-held computing devices, microprocessor-based or programmable consumer electronics, and the like, each of which can be operatively coupled to one or more associated devices.

The system memory 1206 can include computer-readable storage such as a volatile (VOL) memory 1210 (e.g., random access memory (RAM)) and non-volatile memory (NON-VOL) 1212 (e.g., ROM, EPROM, EEPROM, etc.). A basic input/output system (BIOS) can be stored in the non-volatile memory 1212, and includes the basic routines that facilitate the communication of data and signals between components within the computer 1202, such as during startup. The volatile memory 1210 can also include a high-speed RAM such as static RAM for caching data.

The system bus 1208 provides an interface for system components including, but not limited to, the system memory 1206 to the processing unit(s) 1204. The system bus 1208 can be any of several types of bus structure that can further interconnect to a memory bus (with or without a memory controller), and a peripheral bus (e.g., PCI, PCIe, AGP, LPC, etc.), using any of a variety of commercially available bus architectures.

The computer 1202 further includes machine readable storage subsystem(s) 1214 and storage interface(s) 1216 for interfacing the storage subsystem(s) 1214 to the system bus 1208 and other desired computer components. The storage subsystem(s) 1214 can include one or more of a hard disk drive (HDD), a magnetic floppy disk drive (FDD), and/or optical disk storage drive (e.g., a CD-ROM drive DVD drive), for example. The storage interface(s) 1216 can include interface technologies such as EIDE, ATA, SATA, and IEEE 1394, for example.

One or more programs and data can be stored in the memory subsystem 1206, a machine readable and removable memory subsystem 1218 (e.g., flash drive form factor technology), and/or the storage subsystem(s) 1214 (e.g., optical, magnetic, solid state), including an operating system 1220, one or more application programs 1222, other program modules 1224, and program data 1226.

The one or more application programs 1222, other program modules 1224, and program data 1226 can include the entities and component of the system 100 of FIG. 1, the entities and components of the system 200 of FIG. 2, the visualizations and gestures described in FIGS. 3-8, and the methods represented by the flow charts of FIGS. 9-11, for example.

Generally, programs include routines, methods, data structures, other software components, etc., that perform particular tasks or implement particular abstract data types. All or portions of the operating system 1220, applications 1222, modules 1224, and/or data 1226 can also be cached in memory such as the volatile memory 1210, for example. It is to be appreciated that the disclosed architecture can be implemented with various commercially available operating systems or combinations of operating systems (e.g., as virtual machines).

The storage subsystem(s) 1214 and memory subsystems (1206 and 1218) serve as computer readable media for volatile and non-volatile storage of data, data structures, computer-executable instructions, and so forth. Computer readable media can be any available media that can be accessed by the computer 1202 and includes volatile and non-volatile internal and/or external media that is removable or non-removable. For the computer 1202, the media accommodate the storage of data in any suitable digital format. It should be appreciated by those skilled in the art that other types of computer readable media can be employed such as zip drives, magnetic tape, flash memory cards, flash drives, cartridges, and the like, for storing computer executable instructions for performing the novel methods of the disclosed architecture.

A user can interact with the computer 1202, programs, and data using external user input devices 1228 such as a keyboard and a mouse. Other external user input devices 1228 can include a microphone, an IR (infrared) remote control, a joystick, a game pad, camera recognition systems, a stylus pen, touch screen, gesture systems (e.g., eye movement, head movement, etc.), and/or the like. The user can interact with the computer 1202, programs, and data using onboard user input devices 1230 such a touchpad, microphone, keyboard, etc., where the computer 1202 is a portable computer, for example. These and other input devices are connected to the processing unit(s) 1204 through input/output (I/O) device interface(s) 1232 via the system bus 1208, but can be connected by other interfaces such as a parallel port, IEEE 1394 serial port, a game port, a USB port, an IR interface, etc. The I/O device interface(s) 1232 also facilitate the use of output peripherals 1234 such as printers, audio devices, camera devices, and so on, such as a sound card and/or onboard audio processing capability.

One or more graphics interface(s) 1236 (also commonly referred to as a graphics processing unit (GPU)) provide graphics and video signals between the computer 1202 and external display(s) 1238 (e.g., LCD, plasma) and/or onboard displays 1240 (e.g., for portable computer). The graphics interface(s) 1236 can also be manufactured as part of the computer system board.

The computer 1202 can operate in a networked environment (e.g., IP-based) using logical connections via a wired/wireless communications subsystem 1242 to one or more networks and/or other computers. The other computers can include workstations, servers, routers, personal computers, microprocessor-based entertainment appliances, peer devices or other common network nodes, and typically include many or all of the elements described relative to the computer 1202. The logical connections can include wired/wireless connectivity to a local area network (LAN), a wide area network (WAN), hotspot, and so on. LAN and WAN networking environments are commonplace in offices and companies and facilitate enterprise-wide computer networks, such as intranets, all of which may connect to a global communications network such as the Internet.

When used in a networking environment the computer 1202 connects to the network via a wired/wireless communication subsystem 1242 (e.g., a network interface adapter, onboard transceiver subsystem, etc.) to communicate with wired/wireless networks, wired/wireless printers, wired/wireless input devices 1244, and so on. The computer 1202 can include a modem or other means for establishing communications over the network. In a networked environment, programs and data relative to the computer 1202 can be stored in the remote memory/storage device, as is associated with a distributed system. It will be appreciated that the network connections shown are exemplary and other means of establishing a communications link between the computers can be used.

The computer 1202 is operable to communicate with wired/wireless devices or entities using the radio technologies such as the IEEE 802.xx family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity) for hotspots, WiMax, and Bluetooth™ wireless technologies. Thus, the communications can be a predefined structure as with a conventional network or simply an ad hoc communication between at least two devices. Wi-Fi networks use radio technologies called IEEE 802.11x (a, b, g, etc.) to provide secure, reliable, fast wireless connectivity. A Wi-Fi network can be used to connect computers to each other, to the Internet, and to wire networks (which use IEEE 802.3-related media and functions).

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented graphical interaction system, comprising:
a set of gestures for interaction with a data visualization presented by a presentation device, the data visualization having one or more graphical elements responsive to the gestures; and
a gesture processing component that receives a gesture relative to a graphical element of the data visualization and changes presentation of the data visualization in response thereto.

2. The system of claim 1, wherein one or a combination of the gestures causes access to underlying data of the data visualization to update the data visualization according to an analytical function associated with one or a combination of gestures.

3. The system of claim 1, wherein the set of gestures facilitates direct input by anatomical interaction with the presentation device or indirect input by interaction via an input device.

4. The system of claim 1, wherein the set of gestures include one or a combination of gestures that allow changing presentation of the data visualization to a pie chart.

5. The system of claim 1, wherein the set of gestures include one or a combination of gestures that allow changing presentation of the data visualization to a bar chart.

6. The system of claim 1, wherein the set of gestures include one or a combination of gestures that allow changing presentation of the data visualization to a line chart.

7. The system of claim 1, wherein the set of gestures include one or a combination of gestures that allow selection of multiple elements.

8. The system of claim 1, wherein the set of gestures include one or a combination of gestures that allow exclusion of all elements except selected elements of the data visualization.

9. The system of claim 1, wherein the set of gestures include one or a combination of gestures that when interpreted show additional detail information about the element.

10. A computer-implemented graphical interaction system, comprising:
a set of gestures for interaction with a data visualization presented by a presentation device, the data visualization having one or more graphical elements responsive to the gestures; and
a gesture processing component that receives a gesture relative to a graphical element from direct input by anatomical interaction with the presentation device or indirect input by interaction via an input device, and changes presentation of the data visualization in response thereto based on application of one or more analytical functions.

11. The system of claim 10, wherein the set of gestures include one or more gestures that when received relative to the one or more graphical elements and processed by the gesture processing component allow changing presentation of the data visualization to a different presentation form that includes a pie chart, bar chart, a line chart, or a graph.

12. The system of claim 10, wherein the set of gestures include one or more gestures that when received relative to the one or more graphical elements are processed by the gesture processing component to allow selection of multiple graphical elements.

13. The system of claim 10, wherein the set of gestures include one or more gestures that when received relative to the one or more graphical elements are processed by the gesture processing component to allow exclusion of all graphical elements except selected graphical elements of the data visualization.

14. The system of claim 10, wherein the set of gestures include one or more gestures that when received relative to the one or more graphical elements are processed by the gesture processing component to cause additional details about the one or more graphical elements to be computed and presented.

15. A computer-implemented graphical interaction method, comprising:
receiving one or more gestures relative to elements of a data visualization presented on a display device;
interpreting the one or more gestures;
accessing underlying data associated with the data visualization;
processing the underlying data according to one or more analytical functions associated with the one or more gestures to create updated visualization data; and
presenting a new data visualization based on the updated visualization data.

16. The method of claim 15, further comprising changing form of the data visualization to the new data visualization, which new data visualization is a pie chart, by imposing a generally circular gesture in the data visualization relative to a starting element.

17. The method of claim 15, further comprising changing form of the data visualization to the new data visualization, which new data visualization is a line chart, by imposing a generally wavy line gestured in the data visualization from one border to an opposing border.

18. The method of claim 15, further comprising changing form of the data visualization to the new data visualization, which new data visualization is a bar chart, by imposing a generally bi-directional gesture along a vertical axis in the data visualization.

19. The method of claim 15, further comprising:
performing a select gesture that when processed selects data points of the data visualization; and
performing a remove gesture in the data visualization that when processed removes unselected data points.

20. The method of claim 15, further comprising
performing a select gesture that when processed selects a data point of the data visualization; and
performing a details gesture that generally circumscribes the selected data point and when processed presents additional details associated with the selected data point.
